(19) United States
(12) Patent Application Publication
(10) Pub. No.: US 2008/0203593 A1
(43) Pub. Date: Aug. 28, 2008

(54) Polyvinyl Acetal-Containing Granulate, Method for the Production and the Utilization Thereof

(76) Inventors: Martin Steuer, Liederbach (DE); Bekir Bucak, Nauheim (DE); Simon Jonas, Hattersheim (DE); Matthisas Gutweiler, Huenfelden (DE); Sven Koehnen, Niedernhausen (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/568,532

(22) PCT Filed: Aug. 9, 2004
(86) PCT No.: PCT/EP2004/008896

§ 371 Date: Apr. 16, 2008

(30) Foreign Application Priority Data
Aug. 19, 2003 (DE) 103 38 546.6
Aug. 19, 2003 (DE) 203 12 936.9
May 28, 2004 (DE) 10 2004 026 747.2

(51) Int. Cl. B29B 9/12

(52) U.S. Cl. 264/5; 524/391

(57) ABSTRACT

The invention relates to a method for the production of a granulate containing at least one polyvinyl acetal, wherein a composition containing a polyvinyl acetal is transformed into molten state and granulated in accordance with the desired grain size. The invention also relates to a granulate produced according to said method and to the utilization of the inventive granulate.

The present invention relates to a method for the production of a granulate containing at least one polyvinylacetal, the granulate obtained by means of the method as well as its use.

Polyvinylacetals which are usually obtained by acetylization of the corresponding polyvinylalcohols have long been known and are among other things employed as binding agent for aqueous and/or organic solutions. Furthermore films from polyvinylacetal, especially polyvinylbutyral are of great significance as the connecting layer in laminated safety glasses. However since the processing of the polyvinylacetals does not as a rule take place at the location of their synthesis but at another location they must be stocked in advance and are transported to the site of the further processing. For this the possible saving of space and in an easily manageable form is desirable. Usually therefore the polyvinylacetal produced in the synthesis is compacted, in order in this way to increase the bulk density and at the same time to increase its surface area, which especially facilitates later dissolving or melting of the polyvinylacetal.

The polyvinylacetal granulate obtained in this way however has a considerable proportion of fines, that is particles with comparatively smaller particle sizes, which “give rise to dust” and makes management of the granulate difficult. In the further processing of this type of granulate precautions are needed (protective covers, wearing of dust masks) in order to ensure as clean as possible work with the granulate and at the same time provide a health warning if necessary to prevent the danger of a dust explosion. Furthermore this “dust” is problematic, especially when blending granulates in particular with other additives, since again it anyway further increases the already existing danger of weighing and dosing errors.

Another disadvantage of this type of granulate exists in that it tends to form lumps during dissolution which significantly decreases the rate of dissolving the granulates. Moreover from the technical standpoint polyvinylacetal granulates with higher bulk density are desirable.

An initial basic approach to solving these problems is provided in patent JP 04-258638, which describes a method for production of a polyvinylacetal granulate in which a polyvinylacetal resin is pressed between two rollers at low temperatures and subsequently mills to the desired particle size. By means of this compaction a granulate of comparatively higher bulk density is obtained, which however has a considerable proportion of fines, so that a “dust” of the granulates is furthermore to be deplored. Also there is the tendency for formation of lumps. Furthermore this method is relatively wasteful and thus expensive. In this connection it is clear that the dusts liberated represent a technical safety risk, so that devices are necessary to counter these dusts.

Patent DE-OS 196 50 848 describes a recycling method, wherein plastics with a polyvinylbutyral content are processed. Here laminates are extruded, which contain the salvaged plastic. This application however does not describe the production of a granulate that contains polyvinylbutyral.

Taking into account the state of the art it was the object of the present invention to make polyvinylacetal containing granulates available with a higher bulk density, so as in this manner to be able to achieve a further volume reduction of the packaging unit. Thereby the polyvinylacetal-containing granulates should at the same time have a higher rate of dissolution in conventional solvents for polyvinylacetal, especially in aliphatic alcohols and mixtures of these components, at high as well as at low temperatures. The lumping of granulate known from the state of the art during the dissolving process should be avoided insofar as possible.

Another object of the present invention comprised supplying a comparatively more easily manageable polyvinylacetal-containing granulate, which should especially have the smallest possible proportion of fines.

An object of the present invention was also to discover a method for manufacture of granulate in accordance with the invention which can be carried out simply and cost-effectively.

The method especially should guarantee a specially uniform flow, wherein a particularly high product quality is achieved.

An object of the present invention was also to recognize a method for manufacture of granulates which should be carried out in a simple way and manner and with known devices on a large scale. Here especially the production of granulate should be able to do without apparatuses that as far as possible forestall the liberation of dust.

It was furthermore a goal of the present invention to provide a method for the manufacture of polyvinylacetal-containing granulates which can be carried out at very high rates.

It was moreover a problem of the present invention to specify a method which in view of the components to granulate proceeds as sparingly as possible. Thus especially breakdown determined damages which can occur in granulating polyvinylacetal are diminished.

A further problem of the present invention comprised further rationalizing the processing of the polyvinylacetal-containing granulates. Ways should especially be found to as best as possible eliminate the risk of weighing and dosing errors during the blending of polyvinylacetal-containing granulates with other additives.

It was additionally a goal of the present invention to demonstrate specially suitable application areas of the granulates in accordance with the invention.

These problems are solved as well as other not explicitly identified problems, which are however derivable or opened up without further ado from the relationships discussed here, by means of a method having all the features of claim 1. Suitable modifications of the method in accordance with the invention are satisfied under protection of the subclaims related to claim 1. The granulates obtained by means of the method in accordance with the invention are claimed by the product claims, and the claims in the use category especially describe particularly advantageous areas of application for the granulates in accordance with the invention.

By that means a method for the manufacture of a granulate containing at least one polyvinylacetal is made available, which is characterized in that a polyvinylacetal-containing) composition is converted into the molten state and is granulated corresponding to the desired particle size, succeeds without more ado in the anticipated way in providing a granulate with a higher bulk density, which makes possible an advantageous further volume reduction of the packaging unit. At the same time the granulate in accordance with the invention is distinguished from the state of the art through an increased dissolving rate in all conventional solvents, especially in aliphatic alcohols and mixtures of these components, at low as well as at high temperatures. Formation of granulate lumps during the dissolving process is thereby not observed.

At the same time the teaching in accordance with the invention provides a series of other advantages. To this belong, among others:
The granulate in accordance with the invention has a comparatively narrow particle size distribution. In particular it exhibits if any a significantly lower proportion of fine particles. Therefore in operating/processing of the granulates in accordance with the invention, as a rule employment of dust protection precautions and/or meeting other dust protection measures, especially wearing dust protection masks are avoided.
The granulate in accordance with the invention melts uniformly as conventional polyvinylacetal. Significant advantages arise from it in particular in the extrusion, since essentially smaller pressure fluctuations occur when the granulate in accordance with the invention is utilized. This makes it possible to produce comparatively homogeneously shaped bodies, with less flaws (spots, etc.).
The granulate in accordance with the invention is distinguished in comparison with conventional compacted material by having a greater hardness. As a result of this, comparatively less wear is observed following mechanical stress.
The granulate obtained in accordance with the invention has a higher rate of dissolution in all conventional solvents, especially in aliphatic alcohols and mixtures of these components, at high as well as at low temperatures. Granulate lumping during the process of dissolving is not observed in that connection.
The method for the manufacture of polyvinylacetal-containing granulate in accordance with the invention can be carried out simply and cost-effectively. At the same time the method in accordance with the invention is distinguished in comparison with the state of the art by its high rate.
The method for the manufacture of polyvinylacetal-containing granulate in accordance with the invention is distinguished particularly by a special uniformity and trouble-free operation. Thus, in particular, disturbances, for example pressure fluctuations in the extrusion, etc., are avoided. Through this the product is only very slightly stressed by this means and is distinguished by having a particularly high homogeneity, a specially low incidence of yellowing and a high solubility.
Furthermore the composition that comprises at least one polyvinylacetal can be particularly rapidly melted, wherein the polyvinylacetal requires only a very short heating time. For this the breakdown of the granulate and disadvantages related thereto, for example yellowing, a high level of dispersion and so forth are avoided.
The method for the manufacture of polyvinylacetal-containing granulate in accordance with the invention is of simple type and form and can be carried out cost-effectively on a large scale. In the operation of the method in accordance with the invention additional additives can be directly worked into a granulate as needed with at least one polyvinylacetal, so that in the application of the granulate addition of the other additives in question is no longer necessary. In this way unnecessary processing steps are avoided and the possibility of dosing or weighing errors is avoided. The granulate obtainable in this manner is distinguished by having a very high homogeneity.

The granulate in accordance with the invention is obtainable according to a method in which t least one polyvinylacetal-containing composition is converted to the molten state and is granulated corresponding to the desired particle size. Suitably one proceeds thereby so that at least one polyvinylacetal is converted to the molten state, extruded and granulated to the desired particle size.

The terms “granulate”, “molten state” and “extrusion” are known to the art. “Granulates” denotes particles manufactured by granulation and also comprises amongst other things particles known to the art as microgranulates. Thereby the granulation in accordance with the invention be carried out in known ways, preferably by means of hot face pelletizers (especially for eccentric granulation, knife roller granulation, water ring granulation or underwater granulation), or cold face pelletization (especially through strand granulation or band granulation). These methods are known sufficiently from the related art.

In hot pelletization, occasionally denoted as head) granulation, a polymer melt is formed into strands in hole dies, which immediately upon exit from the die are cut to the desired particle length and cooled down. Processing thereby is usually in air, by means of air-water fluidization, or under water. For a plastic which does not tend to stick together cooling in air can also be carried out, otherwise water is usually used for this purpose. Usually following that drying is included, although in accordance with the invention this is not absolutely necessary, since the polyvinylacetal is not as a rule moistened. Within the scope of a quite special embodiment of the present invention the granulate is therefore, in accordance with the invention, further processed directly or packaged.

In the case of cold granulation strands or bands are extruded, cooled in a water bath and cut into granulates in strand or band granulators. In band granulating the bands must additionally be cut cross-sectionally in the longitudinal direction. Usually following that drying is included, although in accordance with the invention this is not absolutely necessary, since the polyvinylacetal is not as a rule moistened. Within the scope of a quite special embodiment of the present invention the granulate is therefore, in accordance with the invention, further processed directly or packaged.

The shape of the granulate is in accordance with the invention of only secondary importance. In principle any conceivable shape is possible. However, preferably it has an oblong shape, that is its longitudinal extension is larger than its width and height (Cartesian coordinate system). For the purposes of the present invention a specially suitable granulate has a length in the range of 0.1 mm to 5 cm, suitably in the range from 0.5 mm to 1 cm, advantageously in the range from 0.5 mm to 5.0 mm, especially in the range from 0.5 mm to 3 mm. The height of the granulate lies preferably in the range from 0.1 mm to 5 cm, suitably in the range from 0.5 mm and 1.0 cm, advantageously in the range from 0.5 mm to 5 mm, especially in the range from 0.5 mm to 5 mm, especially in the range from 0.5 mm to 3 mm. Thereby the ratio of width to height is preferably in the range from 10:1 to 1:10, suitably in the range from 5:1 to 1:5, especially 1:1.

The term “molten state” denotes the state in which the polyvinylacetal can be worked thermoplastically. Within the scope of the present invention the polyvinylacetal is preferably converted to the molten state by heating to 100 to 340° C., especially to 130 to 200° C. Furthermore, conversion into the molten state suitably employs a single or double screw extruder, a multi-screw kneader, a kneader, a rolling mill and/or a calender.

The method of extrusion denoted also as “strand pressing” signified methods for the manufacture of pipes, wires, profiles, hoses etc from thermoplastic plastics, such as polyvinylacetal. The extrusion thereby takes place in extruders, which are interpreted mostly as worm, rarely as piston extruders. They are loaded with the thermoplastics by means of inlet funnels as well as if necessary other additives, then the material is heated, homogenized and pressed through the shaping nozzles.

Extruders exist in various forms, thus they are differentiated for example according to the number of screws single or double worm extruders, multiscrew kneaders, rolling mills and calenders.

For further details on the above technical terms reference is made to the current technical literature, especially to Römpp's Chemical Encyclopedia (Chemielexikon), 5^{th} edition and to Saechtling, Plastics Handbook (Kunstofftaschenbuch), 27^{th} edition, as well as the literature sources given therein.

In accordance with a quite specially preferred embodiment of the present invention at least one part of the polyvinylacetal-containing composition, preferably at least 70 wt %, specially preferred at least 90 wt %, and quite specially preferred 100 wt % in relation to the total weight of the composition fed into the extruder, fed via at least one side flow line into an extruder. The main entry via which polymers are usually fed into an extruder preferably remains open. The main entry is usually located at an L/D ratio of up to 5. Through this, volatile components can escape via the free access out of the extruder.

The L/D ratio is known in professional circles. Here L stands for the length of the screw and D for the diameter of the screw. Extruders with similar L/D ratios in general have similar extrusion properties. Therefore specifying of the L/D ratio is customary, wherein in general the diameter D of the screw is additionally specified. The length specification “for an L/D ratio of up to 5” is thus given from the multiplication of the specified L/D ratio of 5 with the likewise known screw diameter D, For a crew diameter of 30 mm the specification “for an L/D ratio of up to 5” means that the main entry lies in a range from 0 mm up to a length of 150 mm, in relation to the stating point of the screw. If the diameter amounts to 10 mm, the main entry lies within a range of 0 to 50 mm. Since the main entry has an extension in length, it is established that this specification is related to the point of the main entry, which is the next starting point.

The side stream channel is known among experts, wherein additives to a melt are usually mixed into the extruder via this entry. The feeding in can otherwise be carried out by means of a side stream dosing line connected to the extruder, which can have at least one screw-conveyor. In this case the side stream dosing can for example have one or two screw-conveyors.

Preferably, the side stream dosing line is cooled so that inside this device no melt is produced, but the polyvinylacetal-containing composition is fed into the main extruder as powder. Preferably the temperature in the side stream dosing is less than or equal to the glass transition temperature of the polyvinylacetal or the composition which comprises at least one polyvinylacetal. Preferably the temperature in the side stream dosing is less than or equal to 100° C., especially less than or equal to 80° C. and specially preferred less than or equal to 50° C.

In accordance with a special aspect the screw diameter of the side stream dosing is smaller than the screw diameter of the extruder, wherein the ratio of the screw diameter of the extruder to the screw diameter of the side stream dosing preferably lies in the range from 1.1:1 to 10:1, especially preferred 2:1 to 5:1.

In accordance with another quite specially preferred embodiment of the present invention the region of the extruder from the main entry up to a length of at least 15*L/D, preferably up to a length of 20*L/D can be cooled, in order to solve the previously described problems. In this case the cooling can be carried out by means of cooling of the casing.

The significance of the L/D ratio was presented above. For a screw diameter of 30 mm the specification “up to the length of at least 15*L/D” signifies that the range of the extruder from the main inlet up to a length of at least 450 mm is cooled. For the diameter of 10 mm, the range from the main inlet up to a length of at least 150 mm is cooled. Since the main inlet has an extension over its length, it is clear that this specification is related to the point of the main inlet, which is next to the starting point.

In accordance with another quite special embodiment of the present invention one can cool at least one of the screws, preferably all screws of the extruder, in order to solve the above problems.

Preferably in doing this, the screw over the range of the extruder from the main inlet to a length of at least 5*L/D, especially preferred at least 10*L/D is cooled. The cooling of worms is known in technical circles.

The rotation speed of the extruder of the main stream and, if necessary, of at least one side stream dosing can be easily determined by the person skilled in the art and adjusted.

The rotation speed of the extruder of the main stream preferably lies in the range from 50 rpm to 500 rpm, specially preferred in the range from 60 rpm to 400 rpm.

In accordance with a special aspect of the present invention, in this case the temperature in going over into the molten state can be changed, wherein preferably a temperature increase can be carried out, in order for example to remove volatile components from the mixture. In doing this the temperature can for example be increased stepwise in order to achieve an economic and energy saving removal of these materials. Preferably in for example the supply into the extruder, the temperature is less than or equal to the glass transition temperature of polyvinylacetal or the composition which comprises at least one polyvinylacetal. In accordance with a special aspect, the temperature can lie in the range from 40° C. to 120° C., preferably 80° C. to 120° C. This temperature can subsequently be increased in the main extruder to a range from 100° C. to 220° C., preferably 130° C. to 200° C., wherein this temperature increase can take place over a plurality of stages. Volatile materials can be removed from the composition in known ways, for example by degassing.

Furthermore in preferred variants of the method a few zones of the extruders are not needed, wherein these can be upgraded. Through this other operating advantages arise.

In this connection the term “transfer into the molten state” the process which begins with heating of the composition and ends with the granulation of the composition. Consequently this term embraces also phases in which s homogenization of the molten composition takes place.

The granulate in accordance with the invention is distinguished by having a high level of uniformity and homogeneity and especially has a comparatively narrow particle size distribution with a comparatively small proportion of fines. Methods for determining of the particle size distribution are known to those skilled in the art. They take place in accordance with the invention by determination of d_{z} values (z=1 to 99), which specify that z wt % of the granulate has a diameter smaller than d_{z}. The value d₁₀₀ denotes the maximal diameter of the granulate particles. For ideal spherically shaped particles these values can be determined for example by sieve analysis.

It is apparent to the person skilled in the art that the particle size distribution depends on the particle symmetry and the specific shape of the granulates. For non-ideal spherically shaped granulates therefore the particle size distribution is separately determined relative to each main axis of the granulate, wherein the characterization of the homogeneity of the granulates in the direction of the greatest extension of the granulates (longest principal axis) has been quite specially proved within the scope of the invention.

In accordance with the invention the quotient d₁₀/d₁₀₀, is preferably greater than 0.2, suitably greater than 0.5, preferably greater than 0.75, specially preferred greater than 0.85, quite specially preferred greater than 0.90, favorably greater than 0.95, especially greater than 0.99. The quotient d₅₀/d₁₀₀ is present preferably greater than 0.2, suitably greater than 0.5, preferably greater than 0.75, specially preferred greater than 0.85, quite specially preferred greater than 0.9, favorably greater than 0.95, especially greater than 0.99. The quotient d₅₀/d₉₀ is present preferably greater than 0.70, suitably greater than 0.75, preferably greater than 0.80, specially preferred greater than 0.85, quite specially preferred greater than 0.90, favorably greater than 0.95, especially greater than 0.99.

In accordance with a specially preferred embodiment of the present invention a foaming agent is mixed in during the extrusion. For these purposes quite specially suitable foaming agents are substances, which under the chosen conditions liberate at least one gas, preferably nitrogen, carbon dioxide, a gaseous organic compound and/or water under the extrusion conditions. For this purpose belong especially azo compounds, such as if applicable activated azodicarboxylic acid diamide (155-215° C.), N-nitroso compounds, such as dinitrosopentamethylenetetramine (195° C.), sulfonylhydrazides, like p-toluenesulfohydrazide (155-165° C.), 4,4-oxybis(benzenesulfonic acid hydrazide (145-285° C.), as well as solvents with correspondingly low boiling points, like water. In accordance with the invention specially suitable foaming agents comprise moreover 2,4,6-trihydrazino-1,3,5-triazine (245-285° C.), p-toluenesulfonylsemicarbazide (226-235° C.), 5-phenyltetrazol (240-250° C.) and sodium hydrogencarbonate/citric acid (150-230° C.). The decomposition temperatures of the foaming agents in air are shown above in parentheses.

By means of the method in accordance with the invention granulates with a comparatively high bulk density are obtainable. The term bulk density in this context denotes the quotients from the mass and the volumes of the granulate. The bulk density is determined by pouring the appropriate material into a measurement box, measuring beaker or measuring cylinder and the weight determined. For the purposes of the invention this is carried out in accordance with the standard DIN 543. The bulk densities of the granulate in accordance with DIN 543 is thereby preferably greater than 550 g/l, suitably greater than 600 g/l, advantageously greater than 650 g/l, preferably greater than 700 g/l, specially preferred greater than 750 g/l, especially greater than 800 g/l.

Within the scope of a specially preferred embodiment of the present invention the granulate according to the invention contains, in relation to its total weight, at least 50.0 wt %, preferably at least 60 wt %, suitably at least 75.0 wt % advantageously at least 80.0 wt %, especially at least 90.0 wt % of at least one polyvinylacetal.

Polyvinylacetals are known in the technical community. Preferably the polyvinylacetal is obtainable by reaction of at least one polymer (A) with at least one compound (B), wherein the polymer (A) in each case relative to its total weight comprises the following:
a.) 1.0 to 100 wt %, suitably 1.0 to 99.9 wt % structural units of formula (1)

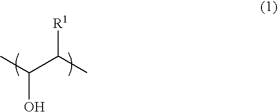

b.) 0 to 99.0 wt % structural units of formula (2)

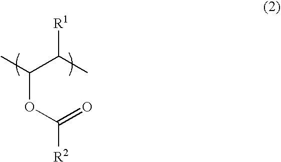

c.) 0 to 70.0 wt %, preferably 0.01 to 70.0 wt %, especially 1.0 to 60.0 wt % structural units of formula (3)

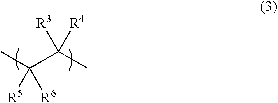

Thereby the particular structural units differ naturally from each other, especially within the scope of the present invention the structural unit comprises formula (3) not the structural units of the formula (1) or (2).

The group R¹ represents in each case independently from each other, hydrogen or methyl, preferably hydrogen.

The group R² designates hydrogen or an alkyl group having 1 to 6 carbon atoms, preferably an alkyl group with 1 to 6 carbon atoms, suitably a methyl, ethyl, n-propyl, iso-propyl, n-butyl, sec-butyl, tert-butyl, n-pentyl or an n-hexyl group, advantageously a methyl or an ethyl group, especially a methyl group.

The groups R³, R⁴, R⁵ and R⁶ are in each case independent of other groups with a molecular weight from 1 to 500 g/mol, suitably hydrogen, an if necessary branched aliphatic or cycloaliphatic group with 1 to 16 carbon atoms, which can if necessary contain one or a plurality of carboxylic acid, carboxylic acid anhydride, carboxylic acid ester, carboxylic acid amide and/or sulfonic acid groups.

Specially preferred structural units of formula (3) are derived from straight chain or branched olefins having 2 to 18 carbon atoms, (meth)acrylic acid, maleic acid, maleic acid anhydride, fumaric acid, itaconic acid, (meth)acrylamides and/or ethylenesulfonic acid. Thereby olefins especially those having an end-located C—C double bond, which preferably has 2 to 6 carbon atoms, especially ethylene, have proved to be quite specially favorable. Furthermore, structural units (3) which are derived from acrylamidopropenylsulfonic acid (AMPS) lead to quite specially advantageous results in accordance with the invention.

The total number of structural units of formula (2) is preferably in the range from 0.1 to 40 mol %, suitably in the range from 0.5 to 25.0 mol %, especially in the range from 1.0 to 15.0 mol %, in each case related to the total number of structural units of formula (1) and (2). Thereby, in accordance with a first preferred embodiment of the present invention a polymer (A) is employed, which in relation to the total number of structural units (1) and (2) contain 1.0 to 2.0 mol % structural units of formula (2). In accordance with a second preferred embodiment of the present invention a polymer (A) is employed, which in relation to the total number of structural units of formula (1) and (2) contains 3.0 to 7.0 mol % structural units of formula (2). In accordance with a third preferred embodiment of the present invention a polymer (A) is employed, which in relation to the total number of structural units of formula (1) and (2), contains 10.0 to 15.0 mol % structural units of formula (2).

In accordance with another special embodiment of the present invention, polymer (A) contains, in each case in relation to the total weight, greater than 50.0 wt %, suitably greater than 60.0 wt %, advantageously greater than 70.0 wt %, especially greater than 80.0 wt % of structural units of formula (1) and/or (2). Specially advantageous results can be achieved thereby with polymers (A), which, in each case in relation to their total weight, contain greater than 85.0 wt %, suitably greater than 90.0 wt %, advantageously greater than 95.0 wt %, especially greater than 99.0 wt % structural units of formula (1) and/or (2). It has thereby been shown in accordance with the invention to be quite specially favorable that the polymer (A1) contains more than 95.0 wt % structural units of formula (1).

Within the scope of the present invention polymer (A) can possess a syndiotactic, isotactic and/or atactic chain structure. Furthermore it can be present as a block copolymer as well as a statistical polymer/copolymer.

The viscosity of polymer (A) is in accordance with the invention of secondary importance, in principle high molecular weight polymers (A) are employed as well as low molecular weight polymers. Nonetheless it has been shown C within the scope of the present invention to be quite specially favorable that the polymer (A) has a viscosity in the range from 1.0 to 70 mPas, preferably in the range from 2.0 to 40 mPas, especially in the range from 2.5 to 35 mPas (measured as a 4 wt % aqueous solution according to Höppler at 20° C., DIN 53015).

The manufacture of polymers (A) to be used in accordance with the invention can be carried out in a known way in a two-stage method. In a first step the corresponding vinyl ester is radically polymerized in a suitable solvent, as a rule water or an alcohol, like methanol, ethanol, propanol and/or butanol by use of a radical starter. If the polymerization is carried out in the presence of radically copolymerizable monomers, then one obtains the corresponding vinyl ester copolymers.

The vinyl ester copolymer is then saponified in a second step, conventionally by transesterification with methanol, wherein the degree of saponification can be adjusted in a known way, for example by variation of the catalyst concentration, the reaction temperature and/or the reaction time. For further details reference is made to the current technical literature especially in Ullmann's Encyclopedia of Industrial Chemistry, fifth edition on CD-Rom, Wiley-VCH, 1997, Keyword: Poly(Vinyl Acetals) and the literature citations given therein.

Formula (4) suffices for compound (B) suffices in this connection.

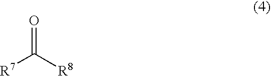

The groups R⁷ and R⁸ are in each case independent of each other, hydrogen, COOH, COOM, an alkyl group with 1 to 10 carbon atoms or an aryl group with 6 to 12 carbon atoms. These alkyl and aryl groups can be thereby substituted with one or more carboxyl, hydroxyl, sulfonic acid groups and/or halogen atoms, like fluorine, chlorine, bromine, iodine. The group M denotes a metal cation or an if applicable alkylated ammonium cation. Specially favorable metal cations selected from elements of the Periodic System of the Elements (PSE) having an electronegativity smaller than 2.0, preferably smaller than 1.5 and comprise especially Li⁺, Na⁺, K⁺, Rb⁺, Cs⁺, Be²⁺, Mg²⁺, Ca²⁺, Sr²⁺, Ba²⁺ as well as Al³⁺. For the purposes of the present invention, belonging to specially suitable ammonium cations are NH₄⁺, H₃NCH₃⁺, H₃NC₂H₅⁺, H₃NC₃H₇⁺, H₃NC₄H₉⁺, H₂N(CH₃)₂⁺, H₂N(C₂H₅)₂⁺, H₂N(C₃H₇)₂⁺, H₂N(C₄H₉)₂⁺, HN(CH₃)₃⁺, HN(C₂H₅)₃⁺, HN(C₃H₇)₃⁺, HN(C₄H₉)₃⁺, N(CH₃)₄⁺, N(C₂H₅)₄⁺, N(C₃H₇)₄⁺ and N(C₄H₉)₄⁺.

For the purposes of the present invention quite specially preferred compounds (B) comprise formaldehyde, acetaldehyde, propionaldehyde, n-butyraldehyde, iso-butyraldehyde, 2-ethoxybutyraldehyde, paraldehyde, 1,3,5-trioxane, capronaldehyde, 2-ethylhexanal, pelargonicaldehyde, 3,5,5-trimethylhexanal, 2-formylbenzosulfonic acid, acetone, ethylmethylketone, butylethylketone and/or ethylhexylketone. According to another preferred embodiment glyoxylic acid HCO—COOH is used as compound (B).

Within the scope of the present invention, the employment of aldehydes has been quite specially proven, that is compounds of formula (4) with R⁷=hydrogen and R⁸=hydrogen, a methyl, ethyl, n-propyl or an iso-propyl group, preferably of formaldehyde, acetaldehyde and/or n-butyraldehyde, especially of n-butyraldehyde, have been quite specially proven.

The quantities of compound (B) can be chosen arbitrarily in principle within the scope of the present invention. Suitably between 0.1 and 300 parts by weight, preferably between 25 and 150 parts by weight, suitably 49 to 99 parts by weight, especially between 50 and 99 parts by weight, compound (B), in each case in relation to 100 parts by weight polymer (A) are employed.

In accordance with a specially preferred embodiment of the present invention the polyvinylacetal is obtainable by means of the method in which one reacts at least one polymer (A) with at least one compound (B) of formula (4) and at least one monosaccharide, at least one oligosaccharide, at least one polysaccharide or a mixture of at least two of these components, wherein the monosaccharide, the oligosaccharide, the polysaccharide or the mixture, in each case in relation to its or their total weight, contains at least 20 wt % glucose and/or glucose units. These polyvinylacetals are specially suitable as binding agents especially for the manufacture of printing inks and lacquer formulations, since in comparison to the state of the art especially in comparison to the corresponding homo-acetals they have a significantly lower solution viscosity, a significantly improved viscosity stability (constant lower viscosity level) and a higher pigment binding capability. Printing ink and lacquer formulations which contain this type of polyvinylacetal as binding agent show furthermore a higher luster than usual formulations. Further this type of polyvinylacetals have an improved substrate adherence especially on glass surfaces.

The terms monosaccharide, oligosaccharide and polysaccharide are best known from the technical literature. The person skilled in the art can obtain worthwhile hints especially in the textbook by H. Beyer, Textbook of Organic Chemistry Beyer (Lehrbuch der organichen Chemie) Beyer, Walter—22^{nd} edition reworked and updated; by W. Walter; Stuttgart; Hirzel 1991—Chapter 4 Carbohydrates; Pages 425-468 extracted, to which disclosure explicit reference is made herewith.

Monosaccharides denote in the sense of the present invention, preferably reducing sugars, for which the summary formula CₙH₂nOₙ preferably suffices, wherein n is preferably a whole number in the range from 3 to 6, suitably in the range from 4 to 6, preferably 5 or 6, especially 6. They preferably have an unbranched carbon chain. Furthermore the monosaccharides comprise also the numerous natural sugars, in which hydrogen and oxygen do not appear in the ratio of water.

In accordance with the invention the term “monosaccharides” comprises aldehyde sugars, the so-called aldoses, as well as keto sugars, the so-called ketoses, wherein aldoses in accordance with the invention are preferably employed quite specially.

The monosaccharides can in principle have the L-configuration as well as the D-configuration. Accordingly the monosaccharides of the D-series have been proven quite specially for the purposes of the present invention.

In accordance with the invention specially suitable monosaccharides comprise among others the following aldoses:

D-gycerinaldehyde L-gycerinaldehyde, D-erythrose, L-erythrose, D-treose, L-treose, D-rbose, L-rbose, D-arabinose, L-arabinose, D-xylose, L-xylose, D-lyxose, L-lyxose, D-allose, L-allose, D-altrose, L-altrose, D-glucose, L-glucose, D-mannose, L-mannose, D-gulose, L-gulose, D-idose, L-idose, D-galactose, L-galactose, D-talose and L-talose

As well as the following hexoses:

1,3-dihydroxyacetone, D-erythrulose, L-erythrulose, D-ribulose, L-ribulose, D-xylulose, L-xylulose, D-psicose, L-psicose, D-fructose, L-fructose, D-sorbose, L-sorbose, D-tagatose and L-tagatose.

In that connection the employment of D-glucose and/or L-glucose has proved to be specially favorable.

Oligosaccharides in the sense of the present invention represent compounds, which, preferably the previously named compounds, are obtainable through acetal like linkages of 2 to 6 monosaccharides. They comprise therefore disaccharides, trisaccharides, tetrasaccharides, pentasaccharides and hexasaccharides. The individual monosaccharides can thereby be linked with each other via the α-form as well as via the β-form.

In accordance with the invention quite specially suitable oligosaccharides comprise among others the following disaccharides:

Cane sugar (saccharose, β-D-fructofuranosyl-α-D-glucopyranoside), milk sugar (lactose, 4-O-(α-D-galactopyranosyl)-D-glucopyranose and/or 4-O-(β-D-galactopyranosyl)-D-glucopyranose), allolactose (6-O-(α-D-galactopyranosyl)-D-glucopyranose and/or 6-O-(β-D-Galactopyranosyl)-D-glucopyranose), malt sugar (maltose, 4-O-(α-D-glucopyranosyl)-D-glucopyranose and/or 4-O-(β-D-glucopyranosyl)-D-glucopyranose), trehalose (α-D-glucopyranosyl-α-D-glucopyranosid), cellobiose (4-O-(β-D-glucopyranosyl)-D-glucopyranose), gentiobiose (6-O-(β-D-glucopyranosyl)-D-glucopyranose) and melibiose (6-O-(α-D-galactopyranosyl)-D-glucopyranose) as well as the trisaccharide raffinose (6-O-(α-D-galactopyranosyl)-α-D-glucopyranosyl-β-D-fructofuranoside) and maltotriose (preferably 4-O-(α-D-glucopyranosyl)-4-O-(α-D-glucopyranosyl)-D-glucopyranose and/or 4-O—(β-D-glucopyranosyl)-4-O-(β-D-glucopyranosyl)-D-glucopyranose). In accordance with a quite specially preferred embodiment of the present invention. Disaccharides, in particular maltose, saccharose and/or lactose employed.

Polysaccharides represent in the sense of the present invention compounds which are obtainable through acetal type linkage of more than 6 monosaccharides, preferably the previously named compounds. Thereby the individual monosaccharides the individual monosaccharides can be linked with each other via the α-form as well as via the β-form.

To the specially suitable polysaccharides in accordance with the invention belong amongst others starches (Amylum), amylase, amylopectin and cellulose ((1→4)-β-D-glucopyranan). Starch is the assimilation product of green plant cells and is essentially composed of about 20 wt % amylose ((1→4)-α-D-glucopyranan; 100 to 1400 glucose units inside each chain) and about 80 wt amylopectin, which like amylase is composed of D-glucose units, which however are arranged in clustered branched shorter chains, which each contain 20 to 25 glucose units. The linkage within the amylopectin chain takes place α-(1→4) glucosidically, against it at the branch sites α-(1→6) glucosidically. Its relative molecular mass is given as 2300.00 g/mol to 1,000,000 g/mol or higher. Cellulose forms a framework material the main component of the plant cell walls and is the most frequently occurring carbohydrate. Depending on its origin it usually has a molecular weight larger than 200.22 g/mol.

Within the scope of this embodiment mixtures of at least two of the named components, especially mixtures of monosaccharides and oligosaccharides and polysaccharides or of monosaccharides, oligosaccharides and polysaccharides can also be employed.

The monosaccharide, the oligosaccharide, the polysaccharide or the mixture preferably contain, in each case relative to its or their total weight at least 20.0 wt %, preferably at least 50.0 wt %, suitably at least 60.0 wt %, preferably at least 70.0 wt % specially preferred at least 80.0 wt %, especially at least 90.0 wt % glucose and/or glucose units. The type of the linkage of the glucose unit is in this connection in principle insignificant, it can be carried C out via the α-form as well as via the β-form, although in accordance with the invention an α-glucosidic linkage has been quite specially proven.

Within the scope of a quite specially preferred embodiment of the present invention, preferably by means of acid catalysis an at least partially hydrolyzed starch is employed. This has in relation to the total weight, preferably more than 90.0 wt % especially between 91.0 and 98.0 wt % glucose.

The quantities of monosaccharide, oligosaccharide and/or polysaccharide can in principle be arbitrarily selected. Suitably between 0.0 01 and 300 parts by weight, preferably between 0.01 and 150 parts by weight, especially between 001 and 99 wt % monosaccharide, oligosaccharide and/or polysaccharide in each case in relation to 100 parts by weight polymer (A) are employed.

The structure of the polyvinylacetals in accordance with this embodiment is up to this point in time not yet completely clarified. Nonetheless the results thus far indicate that the monosaccharide, oligosaccharide and/or polysaccharide is covalently bonded to the polymer, since apart from conventional blends one is no longer able to isolate it from the polymer for example by means of an extraction (e.g. Soxhlet extraction). It is however self-evident that the teaching of the present invention is not limited to this interpretation.

In accordance with another embodiment of the present invention the polyvinyl acetal is obtainable by means of a method in which one reacts a mixture of 1.) 50.0 to 99.99 parts by weight at least of a polymer (A) and 2.) 0.01 to 50.0 parts by weight of at least one hydroxy compound (C) with at least one compound of formula (4). Thereby the sum of the parts by weight of polymer (A) and hydroxy compound (C) is preferably 100 parts by weight.

This type of polyvinylacetal has comparable properties to conventional “softened” polyvinylacetals, these however last for a longer time. They are suited especially for applications in which the softener normally oozes out over time, since in accordance with this embodiment a change of the property profile is prevented by means of separation, concentrating, migration and/or seeping out of components after longer time, such as for example one year.

The formula (5) describes the hydroxy compound (C).

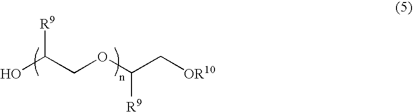

The group R⁹ represents hydrogen or an alkyl group with 1 to 6 carbon atoms, preferably a methyl, ethyl, n-propyl, iso-propyl, n-butyl, sec-butyl, tert-butyl, n-pentyl or an n-hexyl group, especially a methyl group. In accordance with a quite specially preferred embodiment of the present invention the group R⁹ stands for hydrogen.

Thereby the R⁹ groups can be chosen in each case independently of each other, that is each repeating CHR⁹—CH₃—O unit can have another R⁹ group. Consequently the previous definition of the hydroxy compound (C) comprises polyethyleneglycol(monoether) and polypropyleneglycol(monoether) as well also as polyethyleneglycol-co-propyleneglycol(monoether). The latter can be a statistical as well as a blocked type of structure.

The R¹⁰ group denotes hydrogen or an alkyl group with 1 to 19 carbon atoms, preferably a methyl, ethyl, n-propyl, iso-propyl, n-butyl, sec-butyl, tert-butyl, n-pentyl, n-hexyl, n-heptyl, n-octyl, n-nonyl or an n-decyl group, especially a methyl group. In accordance with a quite specially preferred embodiment of the present invention R¹⁰ represents hydrogen.

n is a number larger than 2, preferably a number in the range from 2 to 1,000, suitably in the range from 3 to 300, advantageously in the range from 3 to 25, specially preferred especially in the range from 3 to 10 especially, in the range from 4 to 6. Furthermore especially favorable results can be achieved when n is a number in the range from 10 to 20, especially in the range from 12 to 15.

The proportions of the starting compounds (A), (B) and (C) are chosen in accordance with the invention such that per mole of hydroxyl groups, which the polymer (A) and the hydroxy compound (C) contain in sum, 0.0005 to 0.5 mol of the compound (B) are employed.

Moreover the compounds (B) and (C) are preferably employed in a ratio compound (B)/compound (C) of larger than one. Also the structure of these polyvinylacetals is up to the present time not yet fully explained. Nonetheless, the results to date mean on that basis, that the hydroxy compound (C) is covalently bonded to the polymer, since it—in contrast to the usual softeners—can no longer be extracted from the polymer, for example by an extraction (e.g. by Soxhlet extraction). It is self evident however that the teaching of the present invention is not limited to this interpretation.

The property profile of the polyvinylacetals in accordance with this embodiment differs significantly as well from conventional polyvinylacetals, which do not contain a softener as also from such polyvinylacetals which for the same degree of conversion (degree of acetylization) were plasticized by means of addition of softeners. Compared with conventional polyvinylacetals which do not contain any softener, the polyvinylacetals in accordance with this embodiment at the same degree of acetalization for example have a lower glass transition temperature, a higher shape change capability, a lower entropic elasticity, higher elastic properties, a decreased hardness and mostly an increased adhesion capability.

In contrast to the polyvinylacetals which at the same degree of conversion (degree of acetalization) were plasticized through addition of softeners, they excel especially through an improved long term stability of their properties, above all with the present polyvinylacetals there is a change of the property profile through separation, concentration, migration and/or seeping out of components due to atmospheric effects is also after a longer time, such as for example a year, not observed. Thereby in this connection under atmospheric influences all factors are understood which in the application of polyvinylacetals, especially outside can appear, such as for example sunlight, oxygen, ozone, other gaseous components of air, temperature, dampness, precipitation, dust deposits and so forth.

These improved long-term properties can be observed especially in comparison of the glass transition temperature (preferably measured by means of DSC, Mettler Toledo Star System, heat rate 10 K/min, 2 heats) the entropic elasticity modulus (preferably measured in accordance with DIN 7724 (February 1972)), the tear strength (preferably measured in accordance with DIN 53455), the elongation (preferably measured in accordance with DIN 53455), the water absorption and/or the surface tension of the polyvinylacetals in accordance with this embodiment, with conventional externally plasticized polyvinylacetals. The conversion of the starting compounds (A), (B) as well as if necessary the hydroxy compound (C) and/or the monosaccharide, oligosaccharide, polysaccharide or a mixture of at least two of these components is carried out preferably in at least one solvent. In this connection an especially suitable solvent is water.

Furthermore the reaction is favorably carried out in the presence of acid catalysts. Suitable acids comprise as well as organic acids, such as for example acetic acid, also mineral acids, like hydrochloric acid, sulfuric acid and/or nitric acid, wherein the use of hydrochloric acid, sulfuric acid and/or nitric acid has been specially proven in the art. The reaction is preferably carried out in such a manner that a mixture of components (A), (B) if necessary the hydroxy compound (C) and/or the monosaccharide, oligosaccharide and/or polysaccharide or a mixture thereof is prepared in aqueous solution and subsequently the acid catalyst is stirred into this solution, and subsequently the monosaccharide, oligosaccharide and/or polysaccharide or a mixture thereof is added. In accordance with a third preferred embodiment of the present invention it has also been shown as favorable to prepare a mixture of components (A) and (B) in aqueous solution, to stir the acid catalyst into this solution and subsequently proceed with the reaction by adding compound (C).

The reaction temperature can be varied over a wide range, but frequently the temperature lies in the range −20.0° C. to 100° C., preferably in the range from 0.0° C. to 80.0° C. Similarly for the pressure at which the reaction is carried out. Thus the reaction can be carried out at reduced pressure as well as also at overpressure. Preferably however it is carried out at normal pressure.

Alternative ways of manufacturing of the polymers are evident to those skilled in the art. Thus it is possible for example, instead of the compound (B) to employ compounds which liberate compounds (B) under the chosen reaction conditions. For this purpose belong amongst others cyclic trimers of aldehydes such as acetals of aldehydes or ketones. Furthermore within the scope of the first preferred embodiment it is self-evidently also possible, to first of all partially acetalize polymer (A) by reaction with a corresponding amount of monosaccharide, oligosaccharide and/or polysaccharide or a mixture thereof and then to react the resulting polymer with compound (B). Further, within the framework of the second preferred embodiment the possibility also exists to first of all partially acetalize polymer (A) by reaction with a corresponding amount of compound (B), then to mix in the hydroxy compound (C) and to react the resulting mixture with a further amount of compound (B).

In accordance with a preferred embodiment of the present invention the polyvinylacetal is cross-linked. In doing this the linkage can take place in a known way, for example by reaction of remaining hydroxyl groups on the polyvinylacetal with di or polyaldehydes. It is however specially favorable, that polyvinylacetal through reaction and intermolecular esterification of remaining hydroxyl groups in the polymer cross-links with an un-acetalized aldehyde carboxylic acid, especially glyoxylic acid.

Within the scope of a further preferred embodiment of the present invention the polyvinylacetal is not cross-linked and thereby preferably has a weight average molecular weight smaller than 1,000,000 g/mol, suitably smaller than 500,000 g/mol, especially smaller than 200,000 g/mol. Thereby the weight average molecular weight can be determined in a known way for example by means of stationary light dispersion. For the purposes of the present invention furthermore gel permeation chromatography has proved specially favorable accompanied by use of a polyvinylacetal calibration.

The polyvinylacetal can be both soluble in water as well as insoluble. This property is dependant on the degree of acetalization of the polyvinylacetal, wherein polyvinylacetals with a small degree of acetalization are more easily soluble in water than polyvinylacetal with a high degree of acetalization.

The previously described polyvinylacetals can be employed alone or as a mixture of two or more polyvinylacetals.

Further the composition can contain other additives.

In accordance with a special aspect of the present invention the polyvinylacetal preferably has a glass transition temperature higher than or equal to 0° C., especially higher than or equal to 60° C. Preferably the glass transition temperature of the polyvinylacetal lies in the range from 5 to 120° C., especially 30 to 110° C. and specially preferred 50 to 100° C. In this connection the glass transition temperature of the polyvinylacetal can in accordance with other preferred aspects lie in the range of 50 to under 65° C., 65 to 85° C. or greater than 85° C. to 100° C.

The composition for the manufacture of granulate, which contains the polyvinylacetal, preferably has a glass transition temperature larger than or equal to 0° C., especially greater than or equal to 60° C. Preferably the glass transition temperature of the composition lies in the range from 5° C. to 120° C., especially 30 to 110° C. and specially preferred 50 to 100° C. In this case the glass transition temperature of the composition can, in accordance with other preferred aspects, lie in the range of 50 to under 65° C., 65 to 85° C. or higher than 85° C. to 100° C.

In case the composition has more than one glass transition these data apply to the first transition which has the lowest temperature.

The measurement of the glass transition temperature can among others be measured by means of DSC (Mettler Toledo Star System, heat rate 10 K/min, 2 heats).

In accordance with a special aspect of the present invention the composition for manufacture of granulate which contains the polyvinylacetal, preferably comprises at least 50 wt %, especially at least 70 wt %, preferably at least 90 wt %, specially preferred at least 95 wt % and quite specially preferred at least 98 wt % polyvinylacetal.

Within the scope of the present invention it can be suitable that the granulate—according to the application—contains other additives. In this connection specially suitable additives comprise other polymer resins, softeners, pigments, fillers, stabilizers, adhesion promoters, anti-sticking agents, rheological aids, pH influencing additives and substances, which catalyze chemical reactions or themselves cause, as well between the polyvinylacetal with itself or with other polymer resins that are present if necessary as well also between the other polymer resins between each other. In accordance with the invention quite specially advantageous additives are fiber strengthening materials, especially short glass fibers, long glass fibers, aramid fibers and/or carbon fibers. Within the scope of a quite specially preferred embodiment the granulate contains at least one antioxidant.

Antioxidants, occasionally also called oxidation inhibitor substances, denote within the scope of the present invention, preferably organic compounds, which inhibit and/or hinder undesirable processes in the polyvinylacetal, determined by the action of oxygen and other oxidative processes. Such compounds have long been known to the art and are employed e.g. in plastics and rubbers (especially to protect against aging), fats (especially for protection against rancidity), oils, animal food, gasoline and spray propellants (especially for protection against hardening), transformer and turbine oil (especially for protection against formation of silt), Aroma materials (especially for protection against formation of undesirable aroma components) and coating materials (especially for protection against formation of skin material).

The action of antioxidants comprises mostly that they function as radical traps for the radicals which appear as free radicals in autooxidation. For further details reference is made to the current technical literature especially the Römpp Encyclopedia of Chemistry; published by J. Falbe, M. Regitz; Stuttgart, New York; 10^{th} edition under the heading “Antioxidants” and the literature cited therein.

For the purposes of the present invention specially suitable antioxidants comprise among others tocopherol, tert. butylmetoxyphenol (BHA), butylhydroxytoluene (BHT), octylgallate, dodecylgallate, ascorbic acid, lactic acid, citric acid, tartaric acid, if necessary substituted phenols, if necessary substituted hydrochinones, if necessary substituted chinones, if necessary substituted brenzcatechines, if necessary substituted aromatic amines, if necessary substituted metal complexes of an aromatic amine, if necessary substituted triazine, organic sulfides, organic polysulfides, organic dithiocarbamates, organic phosphites and organic phosphonates.

In accordance with the invention quite specially preferred granulates have if necessary substituted phenols as antioxidants. The formula (6) preferably suffices for these

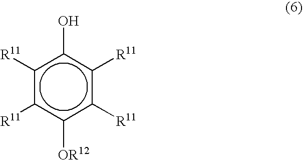

wherein the group R¹¹ in each case independent of each other represents hydrogen, a linear or branched alkyl group with 1 to 8 carbon atoms, especially a methyl, ethyl, n-propyl, iso-propyl, n-butyl, iso-butyl, tert.-butyl, n-pentyl, n-hexyl, n-heptyl or an n-octyl group, which favorably has 1 to 4 carbon atoms, an if necessary substituted cycloalkyl group, preferably with 4 to 8 carbon atoms, especially a cyclohexyl group, an if necessary substituted aryl group, preferably with 6 to 18 carbon atoms or are a halogen, preferably fluorine, chlorine or bromine, and wherein R¹² stands for a linear or branched alkyl group, preferably with 1 to 8 carbon atoms, especially for a methyl, ethyl, n-propyl, iso-propyl, n-butyl, iso-butyl, tert.-butyl, n-pentyl, n-hexyl, n-heptyl or an n-octyl group, which favorably has 1 to 4 carbon atoms, for an if necessary substituted cycloalkyl group, preferably with 4 to 8 carbon atoms, especially for a cyclohexyl group, or for an if necessary substituted aryl group, preferably with 6 to 18 carbon atoms.

Furthermore compounds of formula (7) have also been specially proven for the purposes of the present invention

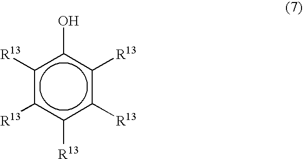

wherein the groups R¹³, in each case independent of each other are hydrogen, a linear or branched alkyl group, preferably with 1 to 8 carbon atoms, especially a methyl, ethyl, n-propyl, iso-propyl, n-butyl, iso-butyl, tert.-butyl, n-pentyl, n-hexyl, n-heptyl or an n-octyl group, which specially preferred has 1 to 4 carbon atoms, an if necessary substituted cycloalkyl group preferably with 4 to 8 carbon atoms, especially a cyclohexyl group, an if necessary substituted aryl group, preferably with 6 to 18 carbon atoms, a halogen, preferably fluorine, chlorine or bromine or a group of formula (8),

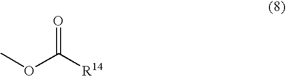

In which R¹⁴ stands for a linear or branched alkyl group with 6 carbon atoms, preferably for a methyl, ethyl, n-propyl, iso-propyl, n-butyl, iso-butyl, tert.-butyl, n-pentyl or n-hexyl group, especially for an ethyl group, In this connection quite specially favorable compounds are satisfied by formula (9)

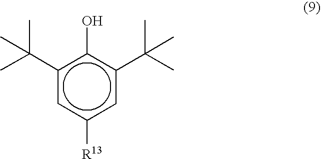

Specially favorable results can moreover also be achieved by use of compounds of formula (10)

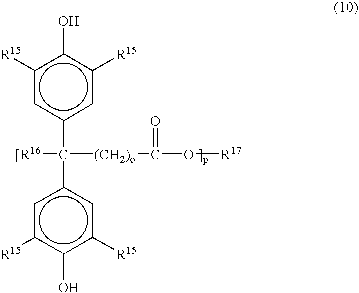

Wherein o is a whole number in the range from 1 to 4 and p is equal to 1 or 2, preferably 2, wherein the R¹⁵ groups, in each case independently of each other are hydrogen, a linear or branched alkyl group, preferably with 1 to 8 carbon atoms, especially a methyl, ethyl, n-propyl, iso-propyl, n-butyl, iso-butyl, tert.-butyl, n-pentyl, n-hexyl, n-heptyl or an n-octyl group, which specially preferred has 1 to 4 carbon atoms or an if necessary substituted cycloalkyl group, preferably with 4 to 8 carbon atoms, especially a cyclohexyl group wherein R¹⁶ denotes hydrogen or a linear or branched alkyl group, preferably with 1 to 8 carbon atoms, especially a methyl, ethyl, n-propyl, iso-propyl, n-butyl, iso-butyl, tert.-butyl, n-pentyl, n-hexyl, n-heptyl or an n-octyl group, especially a methyl group, and wherein preferably with especially a methyl group and wherein R¹⁷ stands for a singly-coordinated alkyl group or a doubly-coordinated alkylene group, preferably a linear α, ω-doubly-coordinated alkylene group, preferably with 1 to 8 carbon atoms, especially for an methyl, methylene, ethyl, 1,2-ethylene, n-propyl, 1-3-n-propylene, iso-propyl, n-butyl, iso-butyl. Tert.-butyl, 1,4-butylene, n-pentyl, 1-5-pentylene, n-hexyl, 1,6-hexylene, n-heptyl, 1,7-heptylene, n-octyl or a 1,8-octylene group, which specially preferred has 1 to 4, quite specially preferred, 2 carbon atoms.

A specially preferred compound of formula (10) is bis-[3,3-bis-(4′-hydroxy-3′-tert.-butylphenyl)butanic acid]-glycolester.

Within the scope of a specially preferred embodiment of the present invention, the antioxidant is an if necessary substituted chinone which formula (11) favorably has the formula (11)

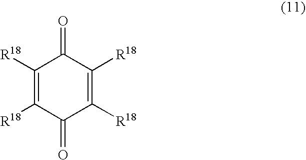

wherein the R¹⁸ groups in each case independent of each other, are hydrogen, a linear or branched alkyl group, preferably with 1 to 8 carbon atoms, especially a methyl, ethyl, n-propyl, iso-propyl, n-butyl, iso-butyl, tert.-butyl, n-pentyl, n-hexyl, n-heptyl or an n-octyl group, which specially preferred comprises 1 to 4 carbon atoms, an if necessary substituted cycloalkyl group, preferably with 4 to 8 carbon atoms, especially a cyclohexyl group, an if necessary substituted aryl group, preferably with 6 to 18 carbon atoms, or a halogen, preferably fluorine, chlorine or bromine.

Furthermore if necessary substituted triazines, especially such as formula (12) have also been quite specially proven for the purposes of the present invention.

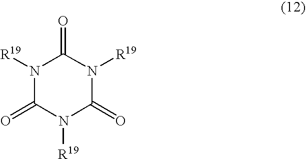

wherein the groups R¹⁹ are an if necessary substituted hydroxyphenyl group, preferably a group of formula (12a), (12b) or (12c),

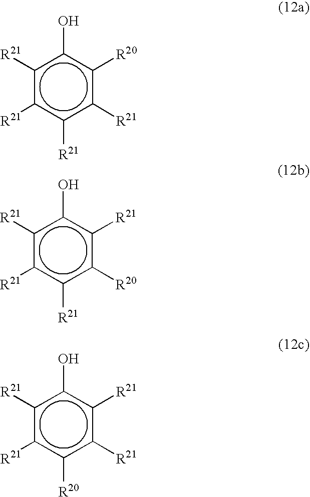

In this connection R²⁰ stands for a linkage or a preferably linear α, ω-doubly-coordinated alkylene group, preferably with 1 to 8 carbon atoms, especially for a methylene, 1,2-ethylene, 1,3-propylene, 1,4-butylene, 1,5-pentylene, 1,6-hexylene, 1,7-heptylene or a 1,8-otylene group, which has specially preferred 1 to 4, quite specially preferred 2, carbon atoms, and the groups R²¹ designate, in each case independently of each other, hydrogen, or a linear or branched alkyl group, preferably with 1 to 8 carbon atoms, especially a methyl, ethyl, n-propyl, iso-propyl, n-butyl, iso-butyl, tert.-butyl, n-pentyl, n-hexyl, n-heptyl or an n-octyl group, which has especially preferred 1 to 4, quite specially 1 or 2 carbon atoms.

Further in accordance with the invention benzofuranones have also proved quite specially favorable as antioxidant. These preferably satisfy the formula (13)

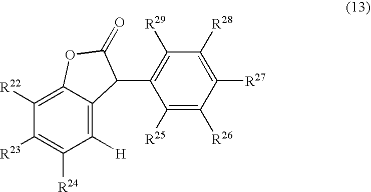

Thereby the groups R²², R²³, R²⁵, R²⁶, R²⁷, R²⁸, R²⁹, denote in each case independently of each other, hydrogen, a hydroxy group, a linear or branched alkyl group, preferably with 1 to 18 carbon atoms, especially a methyl, ethyl, n-propyl, iso-propyl, n-butyl, iso-butyl, tert.-butyl, n-pentyl, n-hexyl, n-heptyl or an n-octyl group, which especially preferred comprises 1 to 4 carbon atoms, an unsubstituted or a mono, di, or trialkyl-substituted phenyl group, wherein the alkyl group preferably contains 1 to 4 carbon atoms, a phenylalkyl group which preferably comprises 7 to 9 carbon atoms, a cycloalkyl group, with preferably 5 to 12 carbon atoms, especially a cyclohexyl group, which can be unsubstituted or mono, di or tri-alkyl substituted, wherein the alkyl group(s) preferably contain(s) 1 to 4 carbon atoms, or an alkoxy group with preferably 1 to 18 carbon atoms, especially a methoxy, ethoxy, n-propoxy, iso-propoxy, n-butoxy, iso-butoxy, tert.-butoxy, n-pentoxy, n-hexoxy, n-heptoxy or an n-octoxy group.

The R²⁴ group is hydrogen, a hydroxy group, a linear or branched alkyl group, preferably with 1 to 18 carbon atoms, especially a methyl, ethyl, n-propyl, iso-propyl, n-butyl, iso-butyl, tert.-butyl, n-pentyl, n-hexyl, n-heptyl or an n-octyl group, which specially preferred comprises 1 to 4 carbon atoms, an unsubstituted or a mono, di, or trialkyl-substituted phenyl group, wherein the alkyl group preferably contains 1 to 4 carbon atoms, a phenylalkyl group, which preferably comprises 7 to 9 carbon atoms, a cycloalkyl group with preferably 5 to 12 carbon atoms, especially a cyclohexyl group, which can be unsubstituted or mono, di, or trialkyl-substituted, wherein the alkyl group(s) preferably contain(s) 1 to 4 carbon atoms, an alkoxy group with preferably 1 to 18 carbon atoms, especially a methoxy, ethoxy, n-propoxy, iso-propoxy, n-butoxy, iso-butoxy, tert.-butoxy, n-pentoxy, n-hexoxy, n-heptoxy or an n-octoxy group or a group of formula (14)

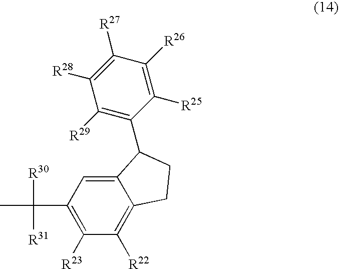

The groups R²², R²³, R²⁵, R²⁶, R²⁷, R²⁸ and R²⁹ thereby possess the previous meaning, wherein preferably at least two of the groups R²⁵, R²⁶, R²⁷, R²⁸ and R²⁹ are hydrogen.

The groups R³⁰ and R³¹ stand in each case independently of each other, for hydrogen or a linear or branched alkyl group, preferably with 1 to 18 carbon atoms, especially a methyl, ethyl, n-propyl, iso-propyl, n-butyl, iso-butyl, tert.-butyl, n-pentyl, n-hexyl, n-heptyl or an n-octyl group, which specially preferred comprises 1 to 4 carbon atoms. Suitably both groups R³⁰ and R³¹ designate a methyl group.

In accordance with the invention quite specially suitable compounds of formula (13) show hydrogen as group R²³ or as group, R²⁵, R²⁶, R²⁷, R²⁸ and R²⁹ hydrogen or as group R²², R²³ and R²⁴ an alkyl group with preferably 1 to 18 carbon atoms, especially a tert.butyl group, or an unsubstituted or mono, di or tri-substituted phenyl group, wherein in the last case the alkyl group preferably contains 1 to 4 carbon atoms.

Within the scope of a quite specially preferred embodiment of the present invention 1,4-dihydroxybenzene, 4-methoxyphenol, 2,5-dichloro-3,6-dihydroxy-1,4-benzochinone, 1,3,5-trimethyl-2,4,6-tris-(3,5-di-tert.butyl-4-hydroxybenzyl)benzene, 2,6-di-tert. butyl-4-methylphenol, 2,4-dimethyl-6-tert. butylphenol, 2,2-Bis [3,5-bis(1,1-dimethylethyl)-4-hydroxyphenyl-1-oxopropoxymethyl)]1,3-propandiylester, 2,2′-thiodiethylbis-[3-(3,5-di-tert.butyl-4-hydroxyphenyl)]propionate, octadecyl-3-(3,5-di-tert.butyl-4-hydroxyphenyl)propionate, 3,5-bis(1,1-dimethylethyl-2,2-methylenebis-(4-methyl-6-tert.butyl)phenol, tris-(4-tert.butyl-3-hydroxy-2,6-dimethylbenzyl)-s-triazin-2,4,6-(1H,3H,5H)trion, tris (3,5-ditert.butyl-4-hydroxy)-s-triazin-2,4,6-(1H, 3H,5H) trion and/or tert. butyl-3,5-dihydroxybenzene are employed as antioxidant. In relation to the total weight of granulate in accordance with the invention the proportion of the antioxidants amounts singly or as a mixture to preferably 0.001 to 2.0 wt %, wherein the concentration of the inhibitors is preferably chosen so that the color number in accordance with DIN 55945 is not adversely affected.

In accordance with a specially preferred embodiment of the present invention the antioxidant is used in combination with synergistically acting nitrogen-containing, sulfur-containing or phosphorus-containing co-stabilizers, preferably of type a) through d) or in combination with mixtures of co-stabilizers of the types a) through d).
a) Nitrogen-containing compounds of formula (15)

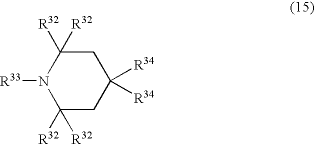

wherein the groups R³², in each case independently of each other are a linear or branched alkyl group, preferably with 1 to 4 carbon atoms, such as a methyl, ethyl, n-propyl, iso-propyl, n-butyl, iso-butyl, or a tert.butyl group, especially a methyl group, or an if necessary substituted cycloalkyl group, wherein R³³ stands for hydrogen, a linear or branched alkyl group, preferably with 1 to 18 carbon atoms, especially for a methyl, ethyl, n-propyl, iso-propyl, n-butyl, iso-butyl, tert.-butyl, n-pentyl, n-hexyl, n-heptyl or an n-octyl group, which has specially preferred 1 to 8, quite specially preferred 1 to 4 carbon atoms, an if necessary substituted cycloalkyl group, preferably with 4 to 8 carbon atoms, especially for a cyclohexyl group, a linear or branched hydroxyalkyl group, preferably with 1 to 18, favored 1 to 8, especially 1 to 4 carbon atoms, or a linear or branched alkoxy group, preferably with 1 to 18, favorably 1 to 8, especially 1 to 4 carbon atoms, specially preferred for hydrogen and wherein the groups R³⁴, in each case independently of each other, denote a linear or branched alkyl group, which can contain one or a plurality, if necessary of different heteroatoms, preferably nitrogen and/or oxygen which can be the same or different such as epoxide groups or wherein the groups R³⁴ form, together with the C-atom of the piperidine ring, form a monocyclic or multicyclic group CL with up to 60 carbon atoms, which can be branched and can contain one or a plurality if necessary of different heteroatoms, preferably nitrogen and/or oxygen, as well as epoxide groups, further the employment of polymeric or copolymeric forms of compounds of formula (15) specially favorable for purposes of the present invention;
b) nitrogen-containing compounds from the group of the aliphatic carboxylic acid hydrazides or dicarboxylic acid hydrazides, preferably with 2 to 12 carbon atoms, especially adipic acid hydrazide, specially preferred acetic acid hydrazide;
c) sulfur-containing compounds from the group of dialkylsulfides and disulfides, wherein the alkyl groups preferably have 4 to 18, especially 8 to 12 carbon atoms. Thiozin compounds of formula RₓSn(S—CH₂—COOR)_{y}, wherein x+y=4, x,y=1 to 3, preferably x,y=2 and R stands for a linear or branched alkyl group, preferably have 1 to 18 carbon atoms, favorably 8 to 14 carbon atoms suitably 8 to 12 carbon atoms, especially for an octyl group, dialkylthiopropionates, wherein the alkyl groups preferably have 1 to 18, favorably 8 to 14 carbon atoms, specially preferred dilaurylthiopropionate;
d) phosphorus-containing compounds from the group of hydrolysis-resistant phosphates, preferably alkylarylphosphites, especially tris-(2,m4-ditert.-butylphenyl)-phosphite.

The foregoing compounds named as costabilizer types a) through d) within the scope of the present invention show surprisingly a synergistic antioxidative and thermostabilizing effectiveness in that they can bring about a further lowering of the oxidative and thermally determined film coloring, whereas, in their application alone such an effect can not be observed. The light stabilizing effect of the costabilizers of formula (15) apparently remain in their synergistic combination with the antioxidants in polyvinylacetals, especially in polyvinylbutyral films, and can contribute additionally to the light stabilization of polyvinylacetal. Particularly good synergistic effectiveness can be achieved through the combination of a plurality of different, preferably up to 4, costabilizers of types a) through d).

Under the nitrogen-containing costabilizers of type a) of the previously specified formula (15), which in accordance with the structure piperidine derivatives represent, are preferably the known light stabilizers of the “HALS” type (Hindered Amine Light Stabilization). It was hereby surprisingly found that their synergistic costabilizing and yellowing-limiting effectiveness increased with increasing molecular weight of the HALS component, whereby polyvinylacetals, preferably molded bodies, especially plasticized PVB planar films, with still stronger decrease in yellowing could be obtained, so that the higher molecular weight HALS compounds of type a) are specially preferred costabilizers. Specially preferred are further polymers and copolymers shapes of compounds of formula (15), since these and others can not likewise migrate from the PVB. Specially preferred are the polymer and copolymer shapes prepared from epoxide group containing compounds of formula (15). As costabilizers of formula (15) the following specially preferred compounds are used: Bis-(2,2,6,6-tetramethylpiperidyl)sebacate, glutarate and succinate,
bis-(1,2,2,6,6-pentamethylpiperidyl)sebacate, glutarate and succinate,
4-stearyloxy- and 4-stearoyloxy-2,2,6,6-tetramethyl-piperidine,
4-stearyloxy- and 4-stearoyloxy-1,2,2,6,6-pentamethylpiperidine,
2,2,6,6-tetramethylpiperidylbehenate, 1,2,2,6,6-pentamethylpiperidylbehenate,
2,2,4,4-tetramethyl-7-oxa-3,20-diazadispiro-[5.1.11.2]-heneicosan-21-on, 2,2,3,4,4-pentamethyl-7-oxa-3,20-diazadispiro-[5.1.11.2]-heneicosan-21-on, 2,2,4,4-tetramethyl-3-acetyl-7-oxa-3,20-diazadispiro-[5.1.11.2]-heneicosan-21-on,
2,2,4,4-tetramethyl-7-oxa-3,20-diaza-20-(β-lauryloxycarbonylethyl)-21-oxodispiro-[5.1.11.2]-heneicosan,
2,2,3,4,4-pentamethyl-7-oxa-3,20-diaza-20-(β-lauryloxycarbonylethyl)-21-oxo-dispiro-[5.1.11.2]-heneicosan,
2,2,4,4-tetramethyl-3-acetyl-7-oxa-3,20-diaza-20-(β-lauryloxycarbonylethyl)-21-oxo-dispiro-[5.1.11.2]-heneicosan,
1,1′,3,3′,5,5′-hexahydro-2,2′,4,4′,6,6′,-hexaaza-2,2′,6,6′-bismethano-7,8-dioxo-4,4′-bis-(1,2,2,6,6-pentamethyl-4-piperidyl)biphenyl,
N,N′,N″,N′″-tetrakis-{2,4-bis-[N-(2,2,6,6-tetramethyl-4-piperidyl)butylamino]-1,3,5-triazin-6-yl}-4,7diazadecan-1,10-diamin,
N,N′,N″,N′″-tetrakis-{2,4-bis-[N-(1,2,2,6,6-pentamethyl-4-piperidyl)butylamino]-1,3,5-triazin-6-yl}-4,7-diazadecan-1,10-diamin,
N,N′,N″,N′″-tetrakis-{2,4-bis-[N-(2,2,6,6-tetramethyl-4-piperidyl)-methoxypropylamino]-1,3,5-triazin-6-yl}-4,7-diazadecan-1,10-diamin,
N,N′,N″,N′″-tetrakis-{2,4-bis-[N-(1,2,2,6,6-pentamethyl-4-piperidyl)-methoxypropylamino]-1,3-5-triazin-6-yl}-4,7-diazadecan-1,10-diamine,
bis-(1,2,2,6,6-pentamethyl-piperidyl)-n-butyl-3,5-di-tert.-butyl-4-hydroxybenzylmalonate,
tris-(2,2,6,6-tetramethyl-4-piperidyl)-nitrilotriacetate,
tetrakis-(2,2,6,6-tetramethyl-4-piperidyl)-1,2,3,4-butantetracarboxylic acid,
1,1′-(1,2-Ethandiyl)-bis-(3,3,5,5-tetramethyl-piperazinone);
   further poly-N,N′-bis-(2,2,6,6-tetramethyl-4-piperidyl)-1,8-diazadecylene, condensation products of 1-(2-hydroxyethyl)-2,2,6,6-tetramethyl-4-hydroxypiperidine and succinic acid,
   condensation products of N,N′-bis-(2,2,6,6-tetramethyl-4-piperidyl)-hexamethylenediamine and 4-tert.-octylamino-2,6-dichloro-1,3,5-s-triazine, condensation products of N,N′-bis-(2,2,6,6-tetramethyl-4-piperidyl)hexamethylenediamine and 4-morpholino-2,6-dichloro-1,3,5-triazin, as well as polymerized 2,2,4,4-tetramethyl-7-oxa-3,20-diaza-(2,3-epoxipropyl)dispiro[5.1.11.2.]-heneicosan-21-on, obtained from the monomeric compound of formula

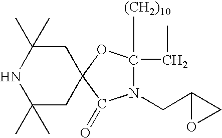

wherein the polymerization takes place via the epoxyropyl group. This polymeric product is a specially preferred stabilizer on the basis of formula (15) of type a). Thereby the molecular weight of the polymerizate is not critical and can vary over a broad range with the premise that the product must always be completely and clearly soluble in the polyvinylacetal.

By shared use of costabilizers of types a) through d) in accordance with the invention, the amount of antioxidant employed preferably amounts to 0.05 to 0.6 wt %, especially 0.07 to 0.4 wt %, specially preferred, 0.1 to 0.3 wt % and the amount of costabilizer employed or of costabilizers mixtures preferably 0.01 to 0.5 wt %, specially 0.1 to 0.4 wt %, wherein the total amount of antioxidant and costabilizer(s) preferably amounts to [symbol] 0.8 wt&%, especially 0.2 to 0.4 wt %, in each case in relation to the total weight of the mixture. The weight ratio of antioxidant to the costabilizer or costabilizers mixture amounts preferably to 90:10 to 20:80.

The proportion of the additives conforms in the first place to the intended application, and accordingly the necessary properties. As well as very small amounts like for example only 0.1 wt % in relation to the total weight of granulate, also very large amounts can be necessary. It has however been shown to be specially favorable, that the total proportion of additives, in each case in relation to the total weight of granulate is at the most 50.0 wt %, preferably at the most 40.0, suitably the most 35.0 wt % ad preferably the most 30.0 wt %, especially smaller than 25.0 wt %.

Within the scope of another quite specially preferred embodiment of the present invention the granulate in accordance with the invention does not contain any antioxidant.

Preferably the composition for manufacture of granulate which contains the polyvinylacetal, at the most 2 wt %, specially preferred at the most 1 wt % external softener. External softeners can be separated by means of suitable methods, for example extraction from the granulate or the composition for preparation of the granulate. The exact parameters of the method are known to those skilled in the art, wherein these are dependant on individual softeners.

The method in accordance with the invention for manufacture of the polyvinylacetal comprising granulates is very economical. Accordingly, by means of the method in accordance with the invention granulates are also especially obtained, which contain polyvinylacetals with a very small polydispersity. In accordance with a special embodiment the granulates obtained containing polyvinylacetals in accordance with the invention comprise a polydispersity M_{w}/Mₙ in the range from 1 to 5, especially 1 to 3. These quantities can for example be ascertained by means of gel permeation chromatography.

The granulates in accordance with the invention can have a relatively small surface area. The surface areas determined in accordance with the BET method (Brunauer, Emmett and Teller) can for example 11e in the range from 0.1 m²/kg to 300 m²/kg, preferably from 0.5 m²/kg to 30 m²/kg and specially preferred 1 m²/kg to 3 m²/kg.

The ethanolic solutions obtained by dissolving the granulates in accordance with the invention have a relatively little cloudiness and yellowish value. In accordance with a special aspect of the present invention, an ethanolic solution has a yellowish value of at the most 5, preferably 3 at the most.

For determination of the yellowish value and the cloudiness a measuring sample of solid material is determined (according to DIN EN ISO 3251), since this allows for the preparation of the 10% solution in the solvents/solvent mixtures. Subsequently the bubble and streak-free solution C is prepared in Hellma cuvettes 50×50 mm with Teflon covers and at the latest 30 seconds after filling, the yellowish value and the cloudiness of the solution are determined with a device from Hunter Lab, Ultra Scan versus deionized water.

Possible fields of use for the granulate in accordance with the invention are apparent to the person skilled in the art. It is especially suitable for all applications which are indicated for polyvinylacetals, especially for polyvinylformals and/or polyvinylbutyrals. On the basis of its characteristic property profile it is however especially advantageous for applications in which the granulate is again dissolved in at least one intermediate step and/or must be melted, since in this connection the advantages of the higher rate of dissolving and/or the uniform rate of melting are especially evident.

In accordance with the invention specially preferred application areas comprise the use of the granulate as raw material for the manufacture of laminated glass films, as binding agent for printing inks and coatings, as preferably temporary binders for ceramics, as binder for thermally developing photosensitive layers and as adhesive material such as removable coatings. Also it is specially advantageously applicable for the manufacture of fibers.

In many cases also new broadened application areas are accessible; for example in the area of additives for building chemicals (tiling adhesives, mortar, bulk cement and the like), in the area of emulsion and suspension polymerization.

An especially preferred application area within the scope of the present invention of the granulate in accordance with the invention are flat shapes and molded bodies, especially films or foils, preferably with a thickness in the range from 0.5 μm to 2.0 mm. These can contain—depending on the desired glass transition temperature Tg—certain amounts preferably less than 60 wt %, especially less than 50 wt %, in relation to the total amounts of polyvinylacetal, of conventional softeners or softener mixtures. A listing of commercial softeners, which contains data concerning their compatibility with polyvinylacetals, especially polyvinylbutyral can for example be found in the publication Modern Plastics Encyclopedia 1981/1982, pages 710-719. Preferred softeners are diesters of aliphatic diols, especially of polyetherdiols or polyetherpolyols, with carboxylic acids, preferably diesters of polyalkylene oxides, especially diesters of di, tri, and tetraethyleneglycol with aliphatic (C₆-C₁₀) carboxylic acids, preferably 2-ethylbutyric acid and n-heptanoic acid, further, diesters of aliphatic or aromatic (C₂-C₁₈) dicarboxylic acids, preferably adipic, sebacic and phthalic acid with aliphatic (C₄-C₁₂) alcohols, preferably dihexyladipate, phthalate, trimellitate, phosphate, fatty acid esters especially, triethyleneglycol-bis-(2-ethylbutyrate), aromatic carboxylic acid esters, especially dibenzoate, and/or hydroxycarboxylic acid esters. Nonetheless within the scope of the present invention it has been shown as quite specially favorable that the polyvinylacetals do not contain any other additives.

The if necessary plasticized polyvinylacetal granulate is extruded preferably by means of thermoplastic extrusion through wide slit nozzles to preferably 0.5 μm to 2.00 mm, especially 0.2 to 2 mm thick flat foils. The extrusion temperature of the extrusion molding material lies in the usual range, preferably between 140 and 250° C., wherein short time also higher temperatures can also be reached. The manufacture of flat foils can also be carried out by means of thermoplastic forming of polyvinylacetal granulate in accordance with the invention on a heatable three-roll mill or a calender.

The granulate can thereby aside from the already previously named stabilizers and softeners contain still other customary additives, such as for example small amounts of basic compounds, preferably for example 0.001 to 0.1 wt % in relation to the polyvinylacetal, alkali hydroxide or alkaline reacting alkali salt for stabilization of polyvinylacetal against acid hydrolysis. This alkali content is usually described as alkali titer of the polyvinylacetal. The if applicable plasticized polyvinylacetal granulate can further contain know anti-sticking in usual amounts, such as for example alkali salts or alkaline earth salts of carboxylic acids, preferably potassium or magnesium salts of formic acid or acetic acid or combinations of these salts with potassium or magnesium salts of hydroxycarboxylic acids, further alkali or alkaline earth salts of dicarboxylic acids or magnesiumacetylacetonate as well as various silanes or siloxanes like for example (3-methyltriethyleneglycoxy)-propylsilane-tris-methyltriethyleneglycolester. The amount employed of these antisticking agents lies preferably in the range from 0.001 to 0.2 wt % in relation to the total weight of granulate in accordance with the invention.

In the shared use of additive light stabilizers, preferably UV-stabilizers, such as for example the known derivatives of benzotriazole it has been surprisingly shown that the amounts employed of these UV stabilizers can be considerably reduced if one utilizes them in combination with the previously described stabilizer systems. This is on the one hand economically advantageous and in addition leads surprisingly to films with improved color values, that is with less intrinsic color in the films which is specially important for their use for the manufacture of glass laminates.

Furthermore, in the film extrusion of plasticized polyvinylacetals, especially polyvinylbutyrals specially important to be able to extrude at if possible as high a bulk temperature as possible in order thereby for the melt viscosity of the plasticized mass to markedly decrease or to be held as low as possible and to be able to achieve as high an extrusion throughput per unit of time as possible, without the extrusion mass being damaged oxidatively or thermally and producing yellowing. Through the use of granulate in accordance with the invention these requirements can be fulfilled to the greatest possible extent.

The foregoing described films are especially suited for the manufacture of laminated safety glasses, which is favorably carried out in a known way according to the autoclave method, for the glass laminate test of 30×30 cm in an autoclave at 140° C., a pressure of 12 bar and a 2 hour hold time. The significantly reduced coloring or yellowing of the films in accordance with the invention can be ascertained in a known way with help of the Yellowness Index according to ASTM-D-1925.

Quite specially the granulate in accordance with the invention is also suited for the manufacture of a polyvinylacetal solution, especially a coating composition. In that connection, the coating composition can be applied onto the most different substrates, especially onto wood, metal, plastic, glass, textiles, paper, leather a well as ceramic and mineral foundations. It can contain as other components, especially other polymer resins, softeners, pigments, fillers, stabilizers, adhesion promoters, rheological aids, pH-value controlling additives and substances, which as well as catalyze or make possible chemical reactions with the polyvinylacetal itself or with the other polymer resins.

The application of the coating can thereby take place as well as a powder that is subsequently melted at a higher temperature, as a melt, as also from a solution or dispersion, wherein the coating composition is applied onto the substrate to be coated and then is dried, by means of coating methods known to a person skilled in the art. Thereby especially in the last two cases it comes to the point of taking advantage of the excellent binder properties of the polyvinylacetal, while it also makes possible an exceedingly uniform setting-up of the solution or the dispersion and at the same time prevents or significantly delays gelling of the coating composition.

In accordance with the invention binding agents denote substances which bind the same or different types of material with each other, wherein the hardening of the materials takes place through physical drying of the solution or dispersion. For coating materials and lacquers, which within the scope of a specially preferred embodiment stand in the foreground of the present invention, binding agents are defined in accordance with DIN 55945 (12/1988) and designate the non-volatile portions without pigment or filler, but including softeners, drying materials and other non-volatile auxiliary materials. The problem of the binding agent is the binding of the pigment particles with each other and with the background.

Within the scope of a preferred embodiment of the present invention the coating is applied as a dispersion to the substrate to be coated. In accordance with DIN 53900 (July 1972) the term “dispersions” stands for a dispersion system having a plurality of phases, of which one continuous (dispersion agent) and at least one other is finely divided (dispersed phase, dispersant). The dispersion agent is in the present case a solvent or mixture which can also contain water. The dispersion agent can be freely chosen according to the application. It comprises for example coloring means (pigments) especially for printing inks.

Suitably, the dispersion agent in the amounts employed in each case is not completely soluble. The solubility at 25° C. in the dispersion means is preferably less than 1.0 g per 100 g dispersion means, suitably smaller than 0.1 g per 100 g dispersion means.

Furthermore the dispersion agent is preferably a solid material that is it has especially at 25° C. and normal pressure (101325 Pa) a dynamic viscosity greater than 10 mPas, suitably greater than 100 kPas.

Within the scope of this embodiment dispersing the dispersing particles is facilitated through the polyvinylacetals, while the boundary surface tension between the two components is lowered, thus a wetting is brought about. The wetting tendency can be derived from the contact angle which the liquids form with the solid surface:

σ₁−γ_{1,2}=σ₂·cos α

[σ₁ or σ₂=surface tension of solid body or liquids, γ_{1,2}=boundary surface tension solid/liquid, α=contact angle (see Römpp Lexikon Chemie—Version 2.0, Stuttgart/New York: Georg Thieme Publishers 1999)—keyword: wetting].

The composition of the dispersion can within the scope of the present invention be freely chosen according to application.

Within the scope of another specially preferred embodiment of the present invention the coating is applied as a solution onto the substrate to be coated. Within the context of the present invention, solutions denote homogeneous mixtures of different materials, wherein still C the tiniest part by volume of the solution has the same type of composition. It comprises at least one solvent that is at least one liquid with a dynamic viscosity, especially at 25° C. and normal pressure (101325 Pa) in the range from 0.1 to 10 mPas.

Within the scope of this embodiment the substance to be dissolving, especially the polyvinylacetal, is preferably completely soluble in the amounts employed in the solvent in each case, especially in alcohols, which preferably comprise 1 to 8 carbon atoms. The solubility in the solvent at 25° C. is preferably greater than 0.1 g per 100 g solvent, suitably greater than 1.0 g per 100 g solvent.

The composition of the solution can be freely chosen according to the application within the scope of the present invention. As solvent or co-solvent means especially alcohols, particularly aliphatic alcohols with 1 to 12, preferably 1 to 8, especially 1 to 4 carbon atoms have been quite specially proven. Quite specially advantageous results can be achieved through use of methanol, ethanol, n-propanol, iso-propanol, n-butanol, sec-butanol, and/or tert.-butanol.

The manufacture of the dispersion or of the solution can be carried out in a known way, preferably mechanically.

Although the previously described polyacetals are quite specially suitable as binding agents, it can be suitable in the individual case to employ other co-binder means, in order for example to improve the pigment wetting or dispersion or adhesion. Suitable co-binding means comprise all known binding means, preferably organic binding means and other polymers.

The desired amounts of co-binder means can be chosen at will according to the application.

Possible application areas of the coating compositions are immediately apparent to the person skilled in the art on the basis of the present description.

They are especially suitable for such applications, which are intended for solutions and dispersions containing conventional binders.

The coating composition is favorably employed as a printing ink. Printing inks are characteristically liquid, pasty or powdery coloring means preparations, which are used in printing machines. In different printing methods the material to be printed can in general be absorptive or not absorptive, flat (e.g. paper, cardboard, leather, films), cylindrical or conical (e.g. cans or other hollow bodies). Relative to the special relationships of printing of textiles reference is made to the technical literature under the heading ,textile printing”.

The printing colors are finely divided mixtures, dispersions or solutions, which are composed of:
coloring means (pigments including filler materials or dyestuffs, for luminous also fluorescent printing,
binding means solutions (mostly called (printing) varnishes), and
additive materials (e.g. drying materials, dilution means, wax dispersions, catalysts or initiators for radiation drying).

The composition of the printing inks if necessary prepared according to the flushing method is not only dependant on the printing method, (high, flat, deep and through printing), but specially on the printing material and on the requirements of the printing result relative to appearance (color tone, transparency or opacity, luster, fluorescence) and physical properties (water, fat, solvent, abrasion resistance, lamination and lacquering capability, etc.). Again a current viewpoint of today—recycling—to be able if necessary to remove the applied printing ink (de-inking).

For further details reference is made especially to the current technical literature, to which disclosure reference is explicitly directed:
Erwin Schulz, ,Flexo-Printing from A to Z”, Polygraph Publishers, Frankfurt am Main, 1987 Reference work on the subject of ,Flexo-Printing”
,The Printing Ink Manual” Chapman & Hall Detailed information on the starting materials and current formulations
Chris Williams ,Printing Ink Tecnology” PIRA Detailed information on printing technology

Within the scope of another preferred embodiment of the present invention the granulate in accordance with the invention used for the manufacture of ionically conducting intermediate layers for electrochromic systems.

In the following the present invention is illustrated by means of examples and comparison examples, and should follow hereby without any limitation to the thinking of the invention. The polyvinylacetal types (Mowital® are obtainable from the firm Kuraray Specialties Europe GmbH.

### EXAMPLE 1

The following named polyvinylacetal types were extruded by means of a Leistritz double screw extruder of the type Micro 27 (GL 44 D (300 rpm, ca. 10 kg/h throughput, gravimetric solid material dosing, 3 mm 2-hole nozzles, water bath, granulator), wherein the polyvinylacetal powder is evenly dosed and was melted in the extruder. The melt was degassed, discharged and the resulting molten strands were cooled and granulated. The exact invention parameters are recorded in Table 1. A comparison of the properties of the granulate and the powder employed are found in Table 2. It is recognized that the granulates in accordance with the invention are distinguished through the comparatively higher solid material proportion. Moreover the associated solutions have a comparatively lower viscosity, a comparatively higher yellow value and a comparatively low cloudiness.

TABLE 1
Extrusion Measurement Parameters

| | | | | Temperature Zones | | | | | | | | | | |
|---|---|---|---|---|---|---|---|---|---|---|---|---|---|---|
| | | Drive | Bulk | [° C.] | | | | | | | | | | |
| Mowital - Type | Duration [h] | Current [A] | Pressure [bar]* | 1 | 2 | 3 | 4 | 5 | 6 | 7 | 8 | 9 | 10 | 11 |
| B 18 S | 02:10 | 13.4 | 0.0 | 60 | 80 | 112 | 120 | 143 | 150 | 170 | 170 | 160 | 161 | 150 |
| B 20 H | 02:05 | 9.6 | 0.0 | 60 | 80 | 129 | 130 | 150 | 190 | 200 | 200 | 190 | 190 | 190 |
| B 30 HH | 02:10 | 13.1 | 0.0 | 60 | 80 | 130 | 155 | 175 | 180 | 180 | 180 | 190 | 195 | 180 |
| B 30 H | 02:07 | 15.1 | 0.0 | 60 | 80 | 130 | 155 | 176 | 180 | 180 | 180 | 190 | 195 | 180 |
| B 30 T | 02:09 | 14.5 | 0.0 | 60 | 80 | 130 | 155 | 175 | 180 | 180 | 180 | 190 | 195 | 180 |
| B 45 H | 02:17 | 13.1 | 0.2 | 60 | 80 | 130 | 155 | 176 | 180 | 180 | 180 | 190 | 195 | 180 |
| B 60 HH | 01:45 | 11.8 | 5.6 | 60 | 80 | 140 | 160 | 184 | 190 | 200 | 200 | 199 | 204 | 190 |
| B 60 H | 02:19 | 12.6 | 12.5 | 60 | 80 | 140 | 160 | 185 | 190 | 200 | 200 | 200 | 213 | 195 |
| B 60 T | 02:20 | 12.8 | 11.9 | 60 | 80 | 140 | 160 | 185 | 190 | 200 | 200 | 200 | 215 | 200 |

*Partially not measurable since the products are very viscous

TABLE 2
Property Comparison (granulate/powder)

| | | | | | | | | | Yellow Value | | Cloudiness | |
|---|---|---|---|---|---|---|---|---|---|---|---|---|
| | | | | | Yellow Value | | Cloudiness | | (MEK/Toluene/50 | | (MEK/Toluene | |
| | Viscosity | | | | (Ethanol) | | (Ethanol) | | w/w) | | 50/50 w/w) | |
| | (10% Ethanol) | | Solids Content | | ./.* | | ./.* | | ./.* | | ./.* | |
| | [mPas] | | [%] | | KSE Masurement | | KSE Masurement | | KSE Mesurement | | KSE Mesurement | |
| | DIN EN ISO 2555 | | DIN EN ISO 3251 | | Method | | Method | | Method | | Method | |
| Mowital-Type | Powder | Granulate | Powder | Granulate | Powder | Granulate | Powder | Granulate | Powder | Granulate | Powder | Granulate |
| B 18 S | 18.1 | 18.3 | 99.76 | 99.8 | 5.72 | 6.84 | 3.4 | 4.16 | 7.82 | 8.83 | 5.61 | 3.36 |
| B 20 H | 21.0 | 20.1 | 98.67 | 99.83 | 11.8 | 7.31 | 3.85 | 1.91 | 8.88 | 7.24 | 2.86 | 2.41 |
| B 30 T | 41.3 | 39.0 | 98.43 | 99.89 | 8.81 | 7.74 | 1.37 | 1.08 | nm. | Nm. | nm. | nm. |
| B 30 H | 45.4 | 45.0 | 98.89 | 99.94 | 5.48 | 6.07 | 1.33 | 0.87 | 7.68 | 8.14 | 1.47 | 1.14 |
| B 30 HH | 46.8 | 45.5 | 98.68 | 99.81 | 6.65 | 7.59 | 1.25 | 0.91 | 7.93 | 7.29 | 0.88 | 0.79 |
| B 45 H | 69.0 | 62.4 | 99.98 | 99.94 | 4.73 | 6.28 | 1.12 | 1.08 | 5.07 | 6.59 | 1.71 | 1.19 |
| B 60 HH | 133.5 | 128.7 | 98.91 | 99.86 | 5.31 | 5.87 | 1.15 | 1.21 | 4.97 | 5.38 | 1.13 | 1.1 |
| B 60 T | 204.4 | 206.8 | 98.67 | 99.97 | 3.99 | 4.21 | 1.07 | 1.22 | nm. | nm. | nm. | nm. |
| B 60 H | 214.7 | 203.0 | 99.19 | 99.96 | 3.73 | 4.64 | 0.74 | 1.28 | 6.12 | 6.95 | 1.79 | 1.48 |

*Yellow value and cloudiness are dimensionless numbers

### Measurement Methods:

The solid material is determined from the measurement sample (according to DIN EN ISO 3251), since this is taken into consideration in the preparation of the 10% solution in the solvent/solvent mixtures. Subsequently the solution is prepared bubble and streak-free in Hellma cuvettes 50×50 mm with Teflon covers and at the latest 30 seconds after filling, the yellow value and the cloudiness determined at room temperature with a device from the firm HunterLab, Ultra Scan compared against deionized water.

Toluene (Reidel-de-Häen Order No.: 24526)

Absolute Ethanol denatured with MEK (Reidel-de-Häen Order No.: 24194)

MEK (Reidel-de-Häen Order No.: 33407)

### COMPARISON EXAMPLE 1

Mowital SB 30 HH was compacted by means of a Pharmapaktor L 200/50 P. fitted with smooth concave rollers. For the pre-compaction a cylindrical screw with a conical entry port was used. The bands were collected and subsequently broken into small pieces on a cylindrical disc sieve of Model Series FC 200 on which a wire mesh sieve with an upper particle size of 2.0 or 3.0 mm was mounted. After comminution the granulate produced was subjected to a sieve analysis whose results are shown in

TABLE 3
Results of the Sieve Analysis

Residue in [wt %]

| Sieve size | Comparison | Comparison |
|---|---|---|
| in [μm] | example 1 | example 2 |
| 125 | 97 | 96 |
| 250 | 94 | 95 |
| 355 | 92 | 93 |
| 500 | 87 | 90 |
| 800 | 73 | 87 |
| 1000 | 61 | 84 |
| 1400 | 28 | 70 |
| 2000 | 0 | 48 |
| 3000 | | 0.3 |

### COMPARISON EXAMPLE 2

Mowital B 30H from the firm Kurary Specialties Europe GmbH was extruded at a rate of 15 kg/h in a double screw extruder from the firm Theyson with a screw diameter of 30 mm and an L/D ratio of 44 with side dosing at 20 D. In doing this the powder was fed via the main entry port into the extruder, wherein the temperature in the region of the entry was 50° C., in the melting zone 150° C. and in the nozzle 160° C. The strand obtained was granulated, wherein a granulate with a bulk density of 620 g/l was obtained. At the start there were no problems granulating. After a time of about 10 minutes however strong fluctuations in pressure appeared, wherein the strand was not uniform.

After 5, 10 and 20 minutes in each case a sample of granulate was taken.

From the measured sample the solid material is determined (according to DIN EN ISO 3251), since this is factored into the manufacture of the 10% solution in the solvent/solvent mixture.

Subsequently a 10% ethanolic solution was prepared from the granulates, filled bubble and streak-free into Hellma cuvettes 50×50 mm with a Teflon cover and no later than 30 seconds after filling the yellow value and the cloudiness of the sample is determined with a device from the firm HunterLab, Ultra Scan versus deionized water.

The yellow value of the sample taken after 5 minutes amounted to 1.7, whereas the yellow value of the sample taken after 10 minutes amounted to 8.3. The solution, which was prepared 20 minutes after the sample was taken showed a yellow value of 10.2.

### EXAMPLE 2

The comparison example 2 was essentially repeated, wherein however the PVB powder was fed via side dosing into the extruder. The side dosing cylinder is water-cooled. Over a time period of 2 hours during the extrusion, no pressure fluctuations appeared, wherein over this time period the strand was formed uniformly.

After 5, 10, 20, 60 and 90 minutes in each case a sample of granulate was taken. Subsequently the yellow value of the different samples was determined in accordance with the methods outlined previously.

The yellow value of the samples, which were taken after 5 minutes amounted to 1.8, whereas the yellow value of the sample which was taken after 10 minutes amounted to 1.7. The solution, which was prepared from the sample taken after 20 minutes, showed a yellow value of 1.9. The yellow value of the samples remained essentially constant over the total time, as this showed the yellow values of the samples taken after 60 or 90 minutes, wherein the yellow value of the sample, which was taken after 60 minutes, amounted to 1.8, and the sample taken after 90 minutes amounted to 1.7.

1. A method of for manufacture of a granulate containing at least one polyvinylacetal, characterized in that a polyvinylacetal containing composition is converted into the molten state and granulated corresponding to the desired particle sizes.

2. The method in accordance with claim 1, characterized in that the polyvinylacetal containing composition is converted into the molten state by heating to 100 to 340° C.

3. The method in accordance with claim 1, characterized in that for conversion into the molten state a single or double screw extruder, a multiscrew kneader, a kneader, a rolling mill and/or a calender is employed.

4. The method in accordance with claim 1, characterized in that the granulate is manufactured by hot cutting down, cold cutting down or strand extrusion.

5. The method in accordance with claim 1, characterized in that during conversion to the molten state a foaming agent is added.

6. The method in accordance with claim 1, characterized in that at least one part of the polyvinylacetal-containing composition is transferred via at least one side stream inlet into an extruder.

7. The method in accordance with claim 6, characterized in that at least 90 wt % of the polyvinylacetal-containing composition is transferred via at least one side stream inlet into the extruder.

8. The method in accordance with claim 6, characterized in that the side stream inlet is cooled by means of which at least one part of the polyvinylacetal-containing composition is fed into the extruder.

9. The method in accordance with claim 1, characterized in that the region of the extruder from the main inlet up to a length of at least 15*L/D is cooled.

10. The method in accordance with claim 1, characterized in that at least one of the screws is cooled.

11. The method in accordance with claim 10, characterized in that the screw is cooled over the range of the extruder from the main inlet up to a length of at least 10*L/D.

12. The method in accordance with claim 8, characterized in that the temperature of the cooling means is less than or equal to the glass transition temperature of the composition, which contains at least one polyvinylacetal.

13. The method in accordance with claim 1, characterized in that the temperature in feeding of the polyvinylacetal-containing composition into the molten state is changed.

14. The method in accordance with claim 9, characterized in that the temperature during the conversion into the molten state is increased.

15. The method in accordance with claim 1, characterized in that gaseous compounds, which arise upon conversion of the polyvinylacetal-containing composition into the molten state, are removed from the composition.

16. The method in accordance with claim 15, characterized in that a part of the gaseous compounds is removed via the main entry port of the extruder.

17. The method in accordance with claim 6, characterized in that the side stream input takes place by means of a dosing device with one or two screw-conveyors.

18. The method in accordance with claim 6 characterized in that the extruder screws diameter is larger than the screw diameter of the side stream dosing.

19. The method in accordance with claim 6 characterized in that the ratio of the screw diameter of the extruder to the screw diameter of the side stream dosing lies in the range from 1.1:1 to 10:1.

20. The method in accordance with claim 6 characterized in that the temperature in the region of the side stream dosing is less than or equal to the glass transition temperature of the composition which contains at least one polyvinylacetal.

21. The method in accordance with claim 1 characterized in that the composition for manufacture of granulate which contains the polyvinylacetal, has a glass transition temperature greater than or equal to 0° C.

22. The method in accordance with claim 1 characterized in that the composition for manufacture of granulate which contains the polyvinylacetal, comprises 95 wt % polyvinylacetal.

23. The method in accordance with claim 1 characterized in that the composition for manufacture of granulate, which contains the polyvinylacetal, contains at the most 2 wt % external softener.

24. The granulate obtainable according to a method in accordance with claim 1.

25. The granulate according to claim 24, characterized in that it has a bulk density in accordance with Standard 543 greater than 350 g/l.

26. The granulate in accordance with claim 24, characterized in that it has D₅₀/D₉₀ value greater than 0.70.

27. The granulate in accordance with claim 24, characterized in that in relation to the total weight it contains at least 50.0 wt % of at least one polyvinylacetal.

28. The granulate in accordance with claim 27, characterized in that the polyvinylacetal is obtainable through reaction of at least a polymer (A) with at least a compound (B) wherein the polymer (A) contains
a.) 1.0 to 100.0 wt % structural units of formula (1) 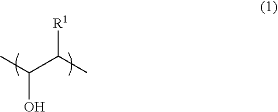
wherein R¹ denotes hydrogen or methyl,
b.) 0 to 99.0 wt % structural units of formula (2) 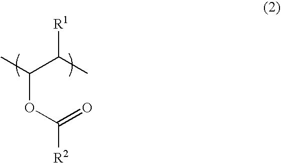
wherein R² represents hydrogen or an alkyl group with 1 to 6 carbon atoms,
c.} 0 to 70.0 wt % structural units of formula (3) 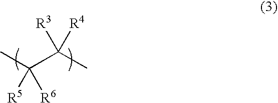
Wherein R³, R⁴, R⁵ and R⁶, denote in each case independently of each other groups with a molecular weight in the range from 1 to 500 g/mol, wherein the compound (B) satisfies formula (4), 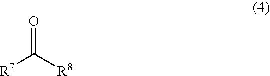
Wherein R⁷ and R⁸, in each case independently of each other are hydrogen, COOH, an alkyl group with 6 to 12 carbon atoms and wherein M is a metal cation or if applicable an alkylated ammonium cation.

29. The granulate in accordance with/claim 24, characterized in that it contains other additives.

30. The granulate in accordance with claim 24, characterized in that it furthermore contains fiber-strengthening materials.

31. The granulate in accordance with claim 30, characterized in that it contains short glass fibers, long glass fibers, aramid fibers and/or carbon fibers as fiber strengthening material.

32. The granulate in accordance with claim 24, characterized in that one solution prepared from the obtained granulate has a yellow value less than or equal to 3.

33. The granulate in accordance with claim 24, characterized in that the polyvinylacetal has a glass transition temperature greater than or equal to 0° C.

34. The use of a granulate according to claim 24 for preparation of a polyvinylacetal solution.

35. The use of a granulate according to claim 24 for preparation of a film.

36. The use of a granulate according to claim 24 for the manufacture of laminated safety glasses.

37. The use of a granulate according to claim 24 as binding agent.
